(19) United States
(12) Patent Application Publication
(10) Pub. No.: US 2026/0219106 A1
(43) Pub. Date: Jul. 30, 2026

(54) ACCURATE CALIBRATION FOR MEASUREMENT OF DISPLAYS

(71) Applicant: Novanta Corporation, Bedford, MA (US)

(72) Inventor: Matthew Falanga, Liverpool, NY (US)

(73) Assignee: Novanta Corporation, Bedford, MA (US)

(21) Appl. No.: 19/461,892

(22) Filed: Jan. 28, 2026

Related U.S. Application Data
(60) Provisional application No. 63/750,317, filed on Jan. 28, 2025.

(51) Int. Cl. G01J 3/02; G01J 3/28

(52) U.S. Cl. CPC G01J 3/0297; G01J 3/0218; G01J 3/0254; G01J 3/28

(57) ABSTRACT

An approach for calibration of spectroradiometers using multiple solid-state emitters that provides a balance between precision and practical implementation. Four solid state emitters having known bandwidths are mounted in a six-inch integrating sphere and viewed by the spectroradiometer to be calibrated to calibrate the wavelength scale of the spectroradiometer for three apertures (0.1 deg, 0.25 deg, and 1 deg). The solid state emitters may be evaluated before or after calibration with an atomic vapor lamp to ensure they have a bandwidth comparable to the bandpass resolution of the spectroradiometer.

### BACKGROUND OF THE INVENTION

### 1. Field of the Invention

The present disclosure relates to metrology devices and, more specifically, to an approach for accurately calibrating a spectrometer for the measurement of displays.

### 2. Description of the Related Art

With the emergence of wide color gamut displays, and the metrics associated with measuring color volume and color gamut rings, higher scrutiny is given to the way in which a spectroradiometer is calibrated. In general, a typical measurement would need its x-axis (pixels) calibrated with respect to wavelength (nm). It would also need its y-axis (digital number) calibrated with respect to radiance (W/cm3/sr). These calibrations should be valid for all spot sizes that are configured for the spectroradiometer with top of scale set by modern display technology (luminance >3000 nits).

Calibration of the wavelength scale in a spectroradiometer is necessary to estimate the spectral radiance of a display. Atomic vapor lamps (such as helium) are long established tools for this purpose as they emit fine spectra in the visible range, although their accuracy is limited to 0.4 nm for the end user of a spectroradiometer (unless computationally intensive signal processing is applied). NIST has achieved higher spectral accuracy using Optical Parametric Oscillator (OPO) technology paired with a spectrum analyzer, although this method's requirement for frequent manufacturer servicing makes it impractical for production environments.

Chromaticity and luminance measurements in display metrology can only be as valid as the spectral scale that is assigned to them. In practice, a robust spectral scale starts with accurate wavelength calibration of spectroradiometers. It has been reported that even sub-nanometer misregistration can shift chromaticity substantially: in tricolor laser sources, a 0.6 nm wavelength error produced Δu, Δv=0.0010. In medical imaging systems also, there is a chromaticity tolerance requirement of Δu, Δv<0.004. For narrow-band primaries typical of modern display technology, this can mean the difference between pass and rework against standard chromaticity bins.

Thus, there is a need in the art for an approach for calibrating display spectroradiometers that can perform a proper wavelength calibration to lower false rejects, reduce inter-lab disputes, and avoid the cost of corrective runs.

### BRIEF SUMMARY OF THE INVENTION

The present invention provides a less complex and more practical solid-state wavelength calibration (such as AlInGaN and AlInGaP). Results with three different apertures are compared to those of the helium calibration without signal processing. A typical spectral power distribution of helium is shown below for reference. The multiple peaks confound accurate wavelength registration, especially for smaller peaks and closely spaced peaks which can be biased due to the blur of the spectral resolution. The final objective is to evaluate the uncertainty of radiometric scales for multiple field apertures at high luminance.

Calibration of the radiometric scale means to quantify the digital number in SI-units. The best practice is to obtain certificate values of a stable incandescent source from a national metrology institute. This paper shows the effect on measurement uncertainty when calibrating all spot sizes with respect to certificate data at 1000 fL. Relative scaling factors have been applied with respect to assigned certificate values for these apertures with an ND filter to avoid saturation.

In one embodiment, the present invention may be a system for calibrating a spectroradiometer that includes a solid-state emitter having a first predetermined bandwidth and a controller coupled to the solid-state emitter and configured to cause the solid-state emitter to emit energy having the first predetermined bandwidth. The solid-state emitter may be positioned in an integrating sphere having an exit port. The controller may be coupled to the solid-state emitter by a multimode fiber. The controller may include an optical parametric oscillator. The optical parametric oscillator may be pumped by a laser spectrum analyzer coupled to the optical parametric oscillator by a single mode fiber. The integrating sphere may include a second solid state emitter having a second predetermined bandwidth, a third solid state emitter having a third predetermined bandwidth, and then a fourth solid state emitter having a fourth predetermined bandwidth. A baffle may be positioned in alignment with the exit port of the integrating sphere.

In another embodiment, the present invention may be a method of calibrating a spectroradiometer that involves the steps of positioning a first solid-state emitter having a first predetermined bandwidth in an integrating sphere, driving the first solid state emitter to direct an output from the first solid state emitter via an exit port of the integrating sphere at the spectroradiometer, detecting the output of the first solid state emitter with spectroradiometer, and repeating steps (a) through (c) using a second solid state emitter having a second predetermined bandwidth, a third solid state emitter having a third predetermined bandwidth, and then a fourth solid state emitter having a fourth predetermined bandwidth in place of the first solid state emitter, wherein the first predetermined bandwidth, the second predetermined bandwidth, the third predetermined bandwidth, and the fourth predetermined bandwidth are different. The step of driving the first solid state emitter may comprise driving the solid state emitter with an optical parametric oscillator. The first solid state emitter may be coupled to the optical parametric oscillator by a multimode fiber. The step of driving the first solid state emitter may further comprise pumping the optical parametric oscillator with a laser spectrum analyzer. The laser spectrum analyzer may be coupled to the optical parametric oscillator by a single mode fiber.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a block diagram of the system for evaluating the accurate wavelength calibration of a display using solid state emitters and using a PR-1050 spectroradiometer.

FIG. 2 is a schematic of a calibration system using OPO according to related art.

FIG. 3 is a series of graphs of four solid-state emitters measured on an exemplary spectroradiometer with a 0.25 deg field aperture at the exit port.

FIG. 4 is a graph of the spectral power density curve of four individual solid-state emitters superimposed on a single graph.

FIG. 5 is a graph showing a residual/delta wavelength comparison that demonstrates outcomes of the two wavelength calibrations methods (atomic lamps vs solid state emitters).

FIG. 6 is a graph of the standard deviation of spectral radiance for 24 unique configurations (8 field apertures and 3 bandwidths) demonstrating outcomes of two radiometric calibrations.

FIG. 7 is a graph of the delta of wavelength calibration between different apertures using the solid-state emitter method.

FIG. 8 is a histogram of delta wavelength between different apertures: atomic lamp (top) vs solid-state emitters (bottom).

FIG. 9 is a graph of wavelength error with respect to Hg audit wavelength (435.8 nm) for each operator and each part tested.

FIG. 10 is a front perspective view of a housing for an integrating sphere that can couple up to six lasers according to the present invention.

FIG. 11 is a rear perspective view of a housing for an integrating sphere that can couple up to six lasers according to the present invention.

FIG. 12 is a front perspective view of a housing having a side removed to allow viewing of an integrating sphere that can couple up to six lasers according to the present invention using fiber-optic connectors.

### DETAILED DESCRIPTION OF THE INVENTION

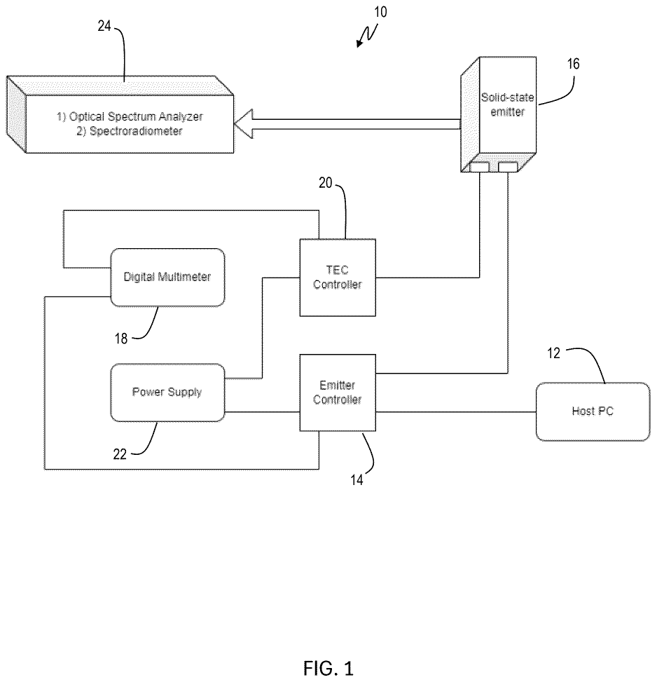

Referring to the figures, wherein like numerals refer to like parts throughout, there is seen in FIG. 1, a system 10 for testing off-the-shelf solid-state emitters for use in a calibration system according to the present invention. A host PC 12 is coupled to an emitter controller 14 that is coupled to the solid-state emitter 16. The emitter controller 14 is further coupled to a digital multimeter 18 that reads the output from the TEC controller 20. The TEC controller 20 and emitter controller 14 may be powered by a common power supply 22. The output of the TEC controller is coupled to the solid-state emitter 16. The output of the solid-state emitter 16 is provided to an optical spectrum analyzer and/or spectroradiometer 24. System 10 is used to perform before/after evaluation with an atomic vapor lamp baseline of off-the-shelf solid-state emitters with a bandwidth comparable to the bandpass resolution of the spectroradiometer, which in this example comprises four high-quality commercial off-the-shelf solid-state emitters with a bandwidth comparable to the bandpass resolution of the spectroradiometer (PR-1050, Novanta). The setup of FIG. 1 was used to characterize each center wavelength with an optical spectrum analyzer (OSA201C, Thorlabs) for several wavelengths in the visible range with descriptive statistics (mean and standard deviation).

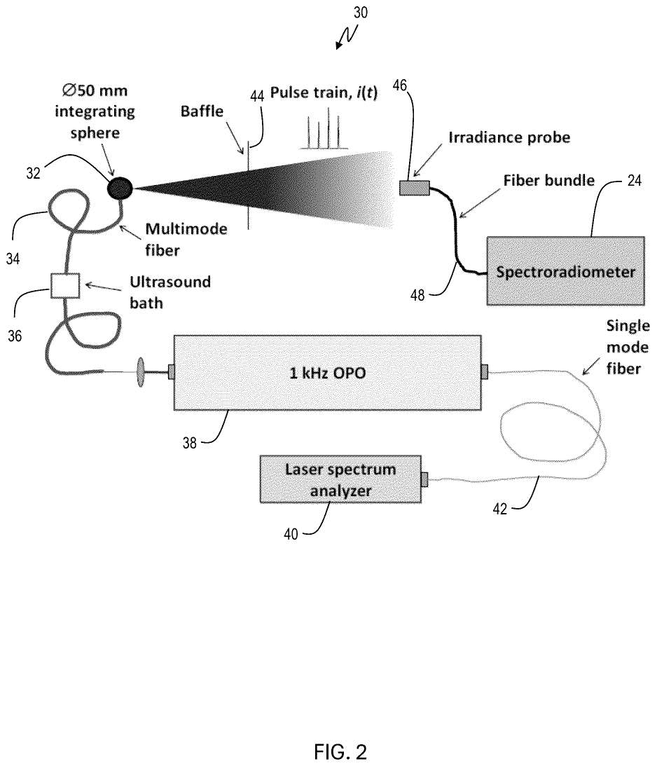

Referring to FIG. 2, calibration system 30 according to the present invention comprises the mounting of each solid-state emitter 16 to a 6-inch integrating sphere 32 having an exit port that is viewed by spectroradiometer 24 to calibrate the wavelength scale of spectroradiometer 24 for three apertures (0.1 deg, 0.25 deg, and 1 deg). In the example of the present invention, four solid-state emitters 16 were used. As seen in FIG. 2, calibration system 30 may be implemented, as an example, using a conventional OPO arrangement where solid-state emitter 16 is driven by a multimode fiber 34 coupled via an ultrasound bath 36 to a 1 kHz optical parametric oscillator (OPO) 38. OPO 38 is pumped by a laser spectrum analyzer 40 coupled to OPO 38 by a single mode fiber 42. The exit port of sphere 32 may then be directed through a baffle 44 and aligned with an irradiance probe 46 that is coupled via a fiber bundle 48 to spectroradiometer 24.

To assess viability of accuracy and repeatability, the nonlinear regression function in Minitab is used to fit a cubic polynomial with the predictors as pixels and response as nanometers. The least-squares fit minimizes residuals between predicted and measured positions of the spectral line spread function centers. The wavelength scale is calibrated for all 512 pixels of the spectroradiometer detector.

Before/after evaluation is performed using system 10 with a relative scaling factor baseline to test spectroradiometer 24 calibrated by certificate values for a tungsten filament lamp inside a 6-inch integrating sphere source (1000 fL) with multiple spot sizes (0.1-2.0 deg) and ND filter (OD 2.0). The spot sizes are each calibrated for three bandwidths (2 nm, 4 nm, 8 nm). This is compared to a baseline that relies only on scaling factors for the ND filter. The measurement field angle was chosen to be 2-deg or less for infinity focus to comply with ICDM IDMS. If a display exhibits viewing angle dependence that is a departure from Lambertian, unacceptable errors can be introduced with field angle greater than 2 deg.

Prior to calibrating the wavelength scale of the spectroradiometer, solid-state emitters 16 were first characterized on the OSA201C optical spectrum analyzer. The mean and standard deviation of the center wavelength from 30 measurements of each light source is shown Table 1 below.

TABLE 1
Descriptive statistics of the calibration sources

| Sold-State | Center Wavelength | Center Wavelength (nm) |
|---|---|---|
| Source# | (nm) Mean | Standard Deviation |
| 1 | 403.4246 | 0.0016 |
| 2 | 514.8542 | 0.0007 |
| 3 | 634.76 | 0.01 |
| 4 | 785.9851 | 0.0003 |

The tolerances of these values can be summarized with standard deviations of at most +/−0.01 nm for all centroids.

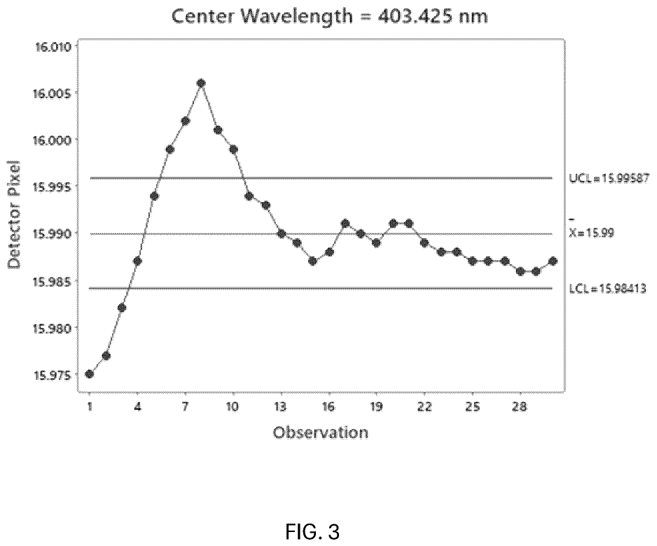

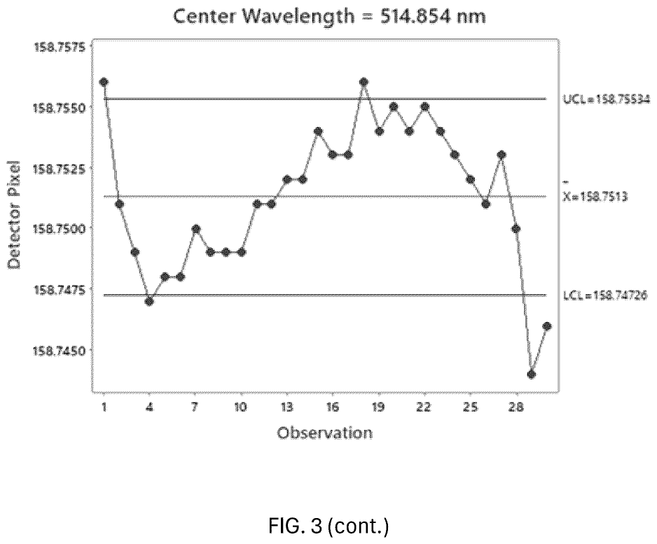

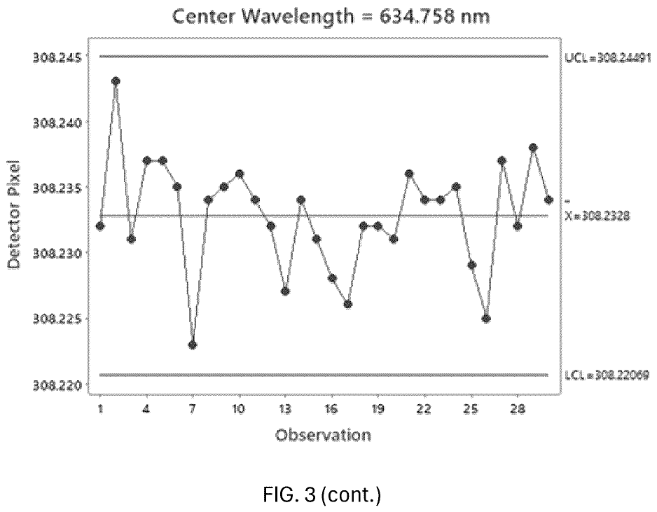

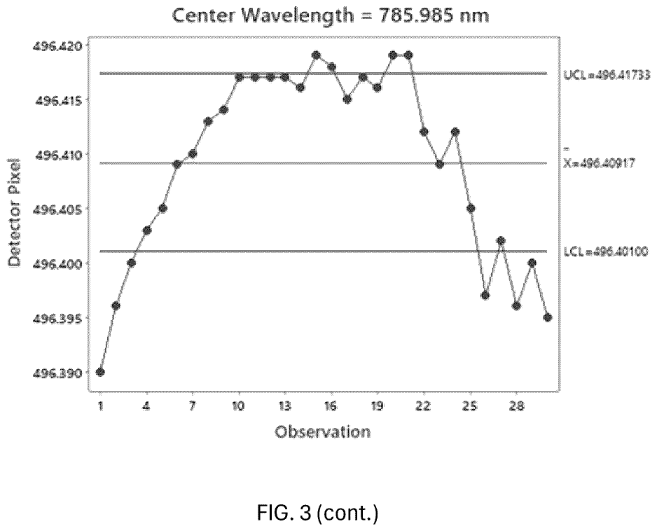

To evaluate repeatability as measured by the PR-1050, control charts were constructed of the individual detector pixel values that corresponded to the center wavelength of each solid-state source, as seen in FIG. 3.

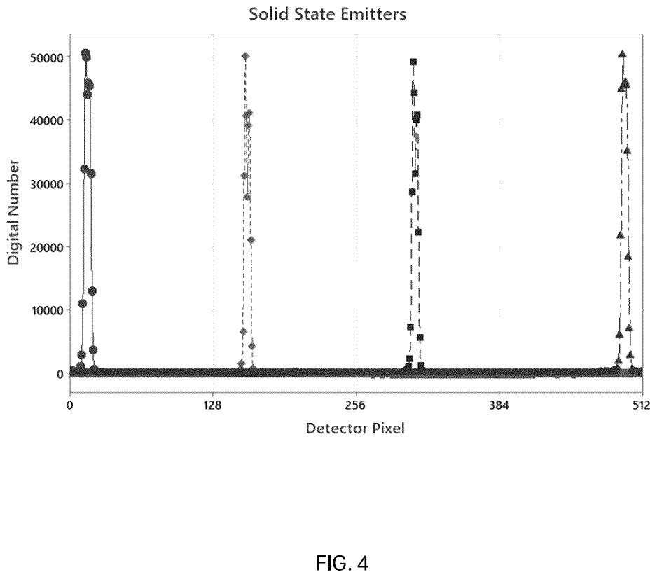

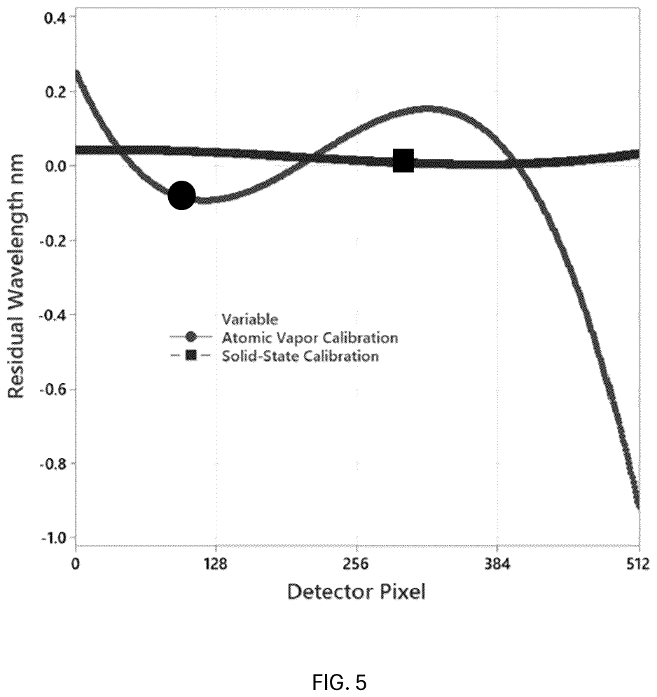

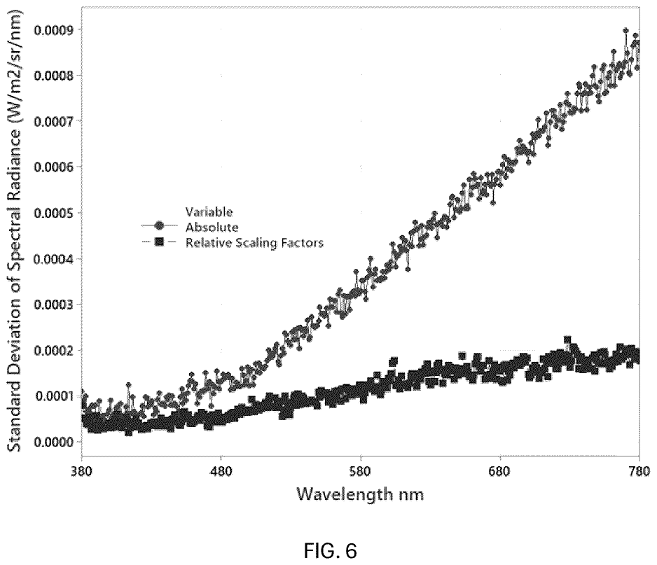

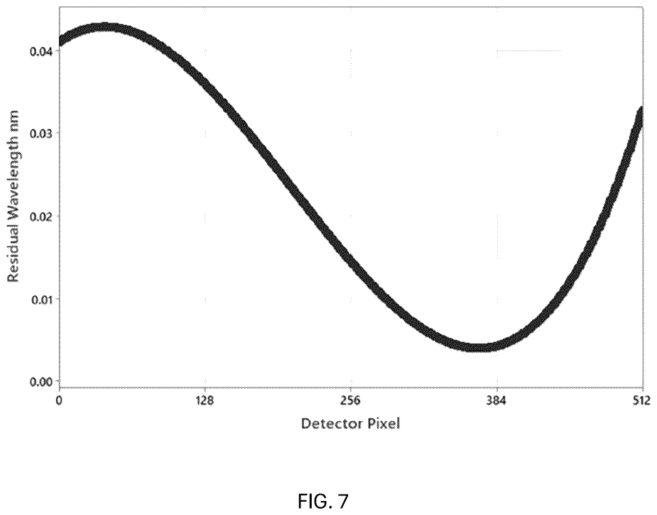

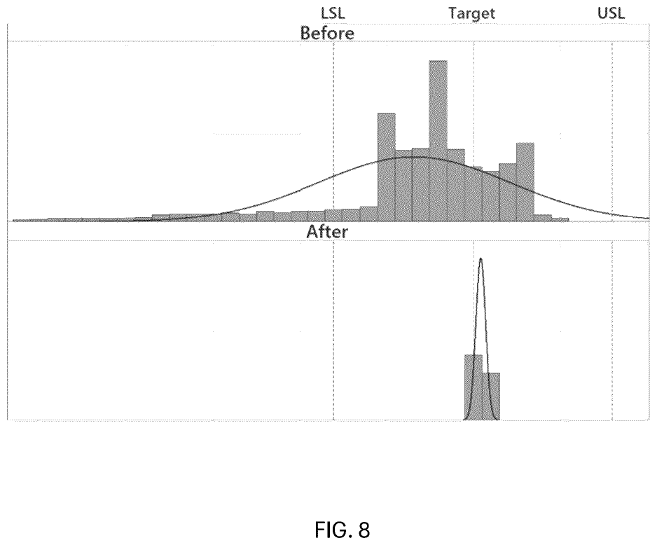

In terms of spectral accuracy, a cubic polynomial wavelength calibration with four solid-state sources yielded 0.025+/−0.02 nm across the visible spectrum as measured on the 5-nm bandpass spectroradiometer with three spot sizes (0.1, 0.25, and 1.0 deg). This contrasts with the helium calibration which was limited to 0.4 nm for much of the wavelength range as shown in FIG. 5. The individual spectral power density curves for all four exemplary solid-state emitters 16 in a single graph are also shown for reference in FIG. 4 for better comparison.

The overall measurement uncertainty is approximately proportional to the first derivative of the measured spectral radiance with respect to wavelength. The expanded measurement uncertainty is determined as the standard uncertainty of measurement multiplied by the coverage factor k=2 such that the coverage probability corresponds to approximately 95%. The relative uncertainty contribution from the wavelength scale has been reduced to at most 0.02% (k=2). With the prior helium wavelength calibration, the contribution was 0.4% (k=2).

In terms of radiometric accuracy with an ND filter, application of the reference responsivity from the certificate values to each aperture yielded a maximum relative uncertainty contribution of 0.35% (k=2). With the prior scaling factor, the contribution was at most 1.5% (k=2).

Atomic vapor lamps are physical standards with negligible variation. The uncertainty in position of the multiple lines emitted by these lamps is limited not by the source but by the precision with which the line center is able to be detected. Radial symmetry and center offset of the peaks at the grating focus challenge this calculation. Difficulties arise particularly for spectroradiometers designed with array spectrometers due to optical aberrations that modify the shape of the line spread function from triangular or trapezoidal shapes. For this reason, center wavelength is the metric of choice to calibrate spectroradiometers. It is also the case that the relative intensity of these peaks is not uniform, which places a burden on the detector integration time to adapt to each constituent peak intensity, further complicating centroid determination.

The solid-state calibration results are preferable to the signal processing enhancements made possible by computationally intensive deconvolutions methods (~0.04 nm on helium). The impracticality of characterizing the centroids of atomic vapors leads to criteria for improvement. The ideal light source must be well-known for its emission centroid, stability, and isolation from neighboring spectra. In the case of light-emitting semiconductors, cleaving the two ends of a p-n junction conveniently satisfies these requirements when tightly controlled for forward bias operation.

Upon examination of the radiometric scale at high luminance, relative scaling factors with an ND filter are deemed not as capable with respect to the reference responsivity from certificate values at each aperture. This finding highlights that other systematic errors exist besides linear scale error.

### Example

Three commercial spectroradiometers were calibrated using 404.78, 513.96, 638.86, and 781.84 nm centroids. The spectroradiometers were equipped with 0.1 deg aperture and fixed 3 nm bandwidth. Two operators performed measurements at three times (morning, noon, evening), resulting in 18 total observations. The wavelength error was measured using the dominant line of a Hg lamp (435.8 nm). The dataset was analyzed using Minitab's Gage R&R (ANOVA method), where every operator measures every part to understand the source of variation.

TABLE 2
Factors used in this study: spectroradiometer parts 1, 2, and 3,
operators A and B, time of day trials 1, 2, and 3.
GAGE R&R

| Parameter | |
|---|---|
| Part | 1, 2, 3 |
| Operator | A, B |
| Trial | 1, 2, 3 |
| Response | Wavelength error at 435.8 |
| | nm |

Results are reported for three spectroradiometers that were deemed qualified in the table below.

TABLE 3
Eighteen observations formatted according to the Gage R&R study.

| Part | Operator | Trial Numbers | Response (nm) |
|---|---|---|---|
| 1 | A | 1 | 0.017 |
| 1 | A | 2 | 0.102 |
| 1 | A | 3 | 0.002 |
| 2 | A | 1 | 0.014 |
| 2 | A | 2 | 0.016 |
| 2 | A | 3 | −0.034 |
| 3 | A | 1 | 0.004 |
| 3 | A | 2 | 0.058 |
| 3 | A | 3 | 0.048 |
| 1 | B | 1 | 0.017 |
| 1 | B | 2 | 0.103 |
| 1 | B | 3 | 0.006 |
| 2 | B | 1 | 0.015 |
| 2 | B | 2 | 0.016 |
| 2 | B | 3 | −0.035 |
| 3 | B | 1 | 0.003 |
| 3 | B | 2 | 0.059 |
| 3 | B | 3 | 0.047 |

The standard by which these instruments were qualified includes out of range stray light index of 0.1%. A test of stray light using long-pass filters (GG475) was performed on a stabilized incandescent lamp at 2856K. When considering the transmitted spectrum, any light at the short wavelengths is out of range stray light as the filter absorbs all actual light. This screening is a quality control (QC) check during the calibration of spectroradiometers: mainly to QC the grating inside the instrument.

The Hg audit wavelength (435.8 nm) was chosen for its spectral position (between the violet and green laser line) and exclusion from the laser calibration set. Since this centroid is dominant, the measurement does not suffer from the signal-to-noise challenges that are common in calibration with the smaller lines found in atomic vapor lamps. The Gage Run Chart function in Minitab seen in FIG. 13 helps visualize the dataset below.

TABLE 4
ANOVA summary statistics with degrees
of freedom abbreviated DF.

| Source | Sum of Squares | DF | F | p-value |
|---|---|---|---|---|
| Part | 0.00652 | 2 | 2.51 | 0.117 |
| Operator | 0.0000009 | 1 | 0.0007 | 0.979 |
| Residual | 0.01815 | 14 | — | — |

TABLE 5
Variance component contribution to total variation.

| Component | Variance | % Contribution |
|---|---|---|
| Repeatability | 0.0012968 | 79.86% |
| Reproducibility | 0.0000000 | 0.00% |
| Part-to-Part | 0.0003271 | 20.14% |
| Total Variation | 0.0016239 | 100.00% |

Almost 80% of the total variation was caused by repeatability (time of day) and 20% part-to-part variation, suggesting a very reproducible process. The relatively low part-to-part variation is an indication that the quality controls in place were successful. The expanded uncertainty (k=2) is equal to 0.0806 nm.

The four-line laser diode wavelength calibration method is thus reproducible and robust when applied to qualified spectroradiometers. The expanded uncertainty of ±0.081 nm (k=2) supports its suitability for high-precision display metrology. Its ability to detect systematic variation between instruments further enhances its utility in quality control and maintenance workflows. The reproducibility and precision of this calibration method are especially relevant for advanced display technologies such as augmented reality (AR), wide gamut laser displays, microLED, and OLED.

While a single wavelength audit (435.8 nm) is reported, the conclusions did not change when auditing a fifth laser wavelength between the last two calibration lines. Similar results were shown with variable bandwidth PR-1050 spectroradiometers with error that positively correlated with bandwidth (2-nm, 4-nm, 8-nm).

This example advances prior work by applying Gage R&R analysis to quantify reproducibility across multiple spectroradiometers and operators. Unlike earlier evaluations focused solely on calibration accuracy, the present example emphasizes the method's robustness with common quality controls. These capabilities make the method particularly valuable for production diagnostics and quality assurance workflows.

An important step in the traceability of a calibration to a National Metrological Institute is quantifying measurement uncertainty. Since the overall measurement uncertainty is approximately proportional to the first derivative of the measured spectral radiance with respect to wavelength, a reproducible and robust wavelength calibration is necessary.

Taken together, the Gage R&R evidence, the sub-nanometer expanded uncertainty (k=2=0.0806 nm), and the audit at a line excluded from the calibration set indicate not only that the four-line laser method is reproducible, but that it is metrologically resilient under realistic production controls. Practically, this matters because the dominant pathway for color error in narrow-band primaries is wavelength registration; the sensitivity scales with the local spectral slope of the display emission, so a small λ bias can project onto the CIE chromaticity plane. By bounding λ-uncertainty at the 0.08 nm level across qualified instruments and operators, the method reduces false rejects, shrinks inter-lab bias, and stabilizes decision rules for conformity assessment. Equally important, the protocol embeds diagnostics (stray-light screening, an out-of-set audit line, and time-of-day repeatability) that act as early-warning indicators for mechanism drift (grating, alignment, aperture, or source stability) that contribute to the uncertainty budget. In the ISO/IEC 17025 context, this creates a traceability chain: a validated wavelength scale with quantified uncertainty, a routine QC program that demonstrates ongoing fitness-for-use, and a forward/backward transfer test that closes the loop across instruments.

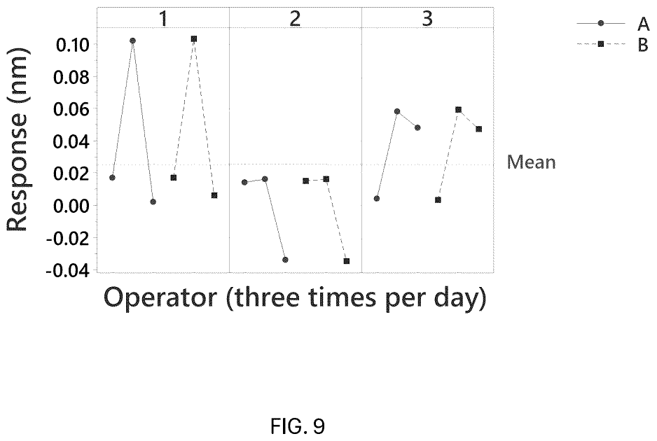

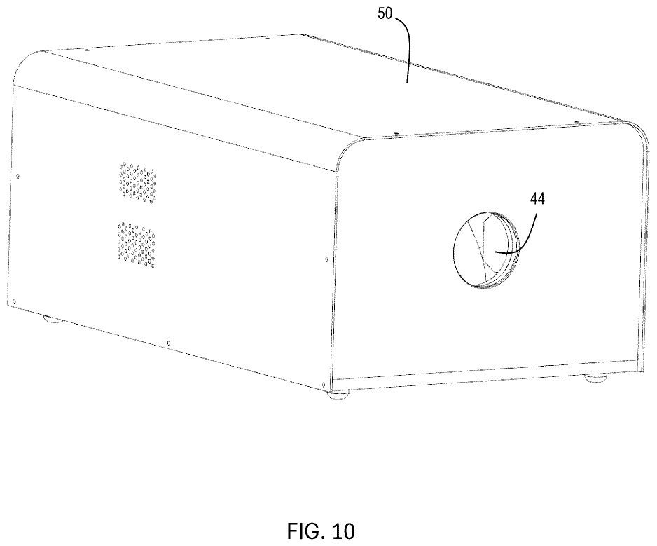

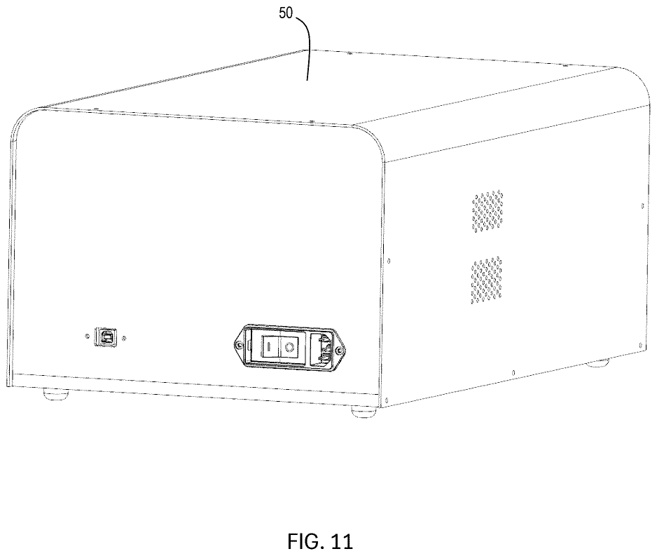

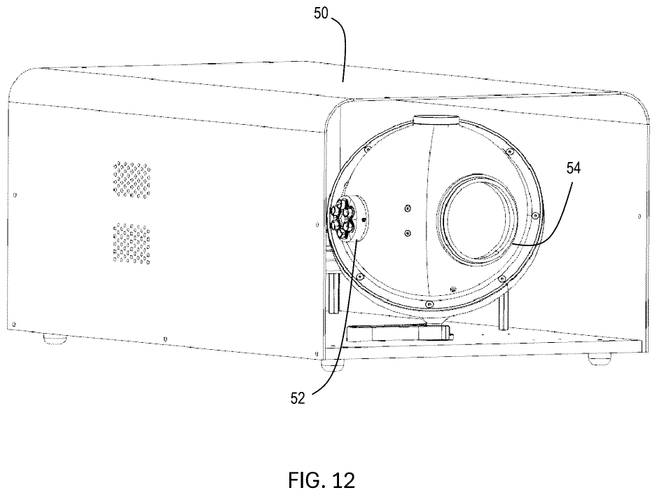

Referring to FIGS. 9 through 12, a housing 50 for an integrating sphere 32 that can accommodate up to six (6) multimode fibers. As further seen in FIG. 16, integrating sphere 32 has six (6) couplings 52 and an exit port 54 that can project through a baffle 44 and be viewed by probe 46 of spectroradiometer 24.

What is claimed is:

1. A system for calibrating a spectroradiometer, comprising:
a solid-state emitter having a first predetermined bandwidth;
a controller coupled to the solid-state emitter and configured to cause the solid-state emitter to emit energy having the first predetermined bandwidth.

2. The system of claim 1, wherein the solid-state emitter is positioned in an integrating sphere having an exit port.

3. The system of claim 2, wherein the controller is coupled to the solid-state emitter by a multimode fiber.

4. The system of claim 3, wherein the controller includes an optical parametric oscillator.

5. The system of claim 4, wherein the optical parametric oscillator is pumped by a laser spectrum analyzer coupled to the optical parametric oscillator by a single mode fiber.

6. The system of claim 5, wherein the integrating sphere includes a second solid state emitter having a second predetermined bandwidth, a third solid state emitter having a third predetermined bandwidth, and then a fourth solid state emitter having a fourth predetermined bandwidth.

7. The system of claim 6, further comprises a baffle positioned in alignment with the exit port of the integrating sphere.

8. A method of calibrating a spectroradiometer, comprising the steps of:
(a) positioning a first solid-state emitter having a first predetermined bandwidth in an integrating sphere;
(b) driving the first solid state emitter to direct an output from the first solid state emitter via an exit port of the integrating sphere at the spectroradiometer;
(c) detecting the output of the first solid state emitter with spectroradiometer; and
(d) repeating steps (a) through (c) using a second solid state emitter having a second predetermined bandwidth, a third solid state emitter having a third predetermined bandwidth, and then a fourth solid state emitter having a fourth predetermined bandwidth in place of the first solid state emitter, wherein the first predetermined bandwidth, the second predetermined bandwidth, the third predetermined bandwidth, and the fourth predetermined bandwidth are different.

9. The method of claim 8, wherein the step of driving the first solid state emitter comprises driving the solid state emitter with an optical parametric oscillator.

10. The method of claim 9, wherein the first solid state emitter is coupled to the optical parametric oscillator by a multimode fiber.

11. The method of claim 10, wherein the step of driving the first solid state emitter further comprises pumping the optical parametric oscillator with a laser spectrum analyzer.

12. The method of claim 11, wherein the laser spectrum analyzer is coupled to the optical parametric oscillator by a single mode fiber.
